(19) United States
(12) Patent Application Publication
(10) Pub. No.: US 2004/0041712 A1
(43) Pub. Date: Mar. 4, 2004

(54) Universal remote control device

(76) Inventors: Roberto Collovini, Colle Umberto (IT); Luigi Borsoi, Colle Umberto (IT)

Correspondence Address: Christopher J McDonald, Hoffman Wasson & Gitler, 2361 Jefferson Davis Highway, Suite 522, Arlington, VA, 22202, US

(21) Appl. No.: 10/450,850

(22) PCT Filed: Dec. 27, 2001
(86) PCT No.: PCT/EP01/15319

(30) Foreign Application Priority Data
Dec. 29, 2000 (IT) VE2000A000054

(51) Int. Cl. G08C 19/00

(52) U.S. Cl. 340/825.69; 348/734; 341/176; 398/107

(57) ABSTRACT

A multi-user remote control device characterised by comprising:

an IR transmitter (2) with a multiple number n of channels,

an IR receiver (12) with n channels tuned to the n channels of the IR transmitter (2),

an RF transmitter (18) associated with the IR receiver (12) and provided with n channels which can be activated via the n connection channels between said IR transmitter (2) and said IR receiver (12),

n RF receivers (6ᵢ), each directly associated with a user device (8ᵢ) and tuned to one of the n channels of said RF transmitter (18).

This invention relates to a multi-user remote control device.

Devices are known for remotely controlling equipment of any type (lights, curtains, doors, household electrical appliances, roll shutters, alarms, etc.) either for reasons of comfort or to avoid the need for cables which besides being laborious to install are inflexible and difficult to modify.

The general principle on which a remote control device is based, is to use a fixed signal receiver associated with the user device to be controlled, and a portable transmitter tuned to the receiver and able to transmit control signals thereto.

The known remote control devices differ on the basis of the type of signals used, and are divided essentially into remote control devices using radio (RF) signals and remote control devices using infrared (IR) signals.

Radio signals are more advantageous in terms of penetrability, they being able to reach the receiver even if not visible, and in particular if it is housed inside the equipment to be controlled. At the same time, radio signals also have limits, such as the risk of disturbing other radio signals, the risk of transmitting undesired commands to other user devices, the need to use a number of channels equal to the number of user devices to be controlled, etc.

In contrast, infrared signals are insensitive to external disturbances, they are directional and hence enable several user devices to be controlled via a single channel even if they are positioned within the same environment, provided there is sufficient space between them; at the same time they cannot overcome obstacles and can operate a receiver only if it is visible to the transmitter.

An object of the invention is to eliminate all the drawbacks of IR and RF remote control devices while at the same time retaining their advantages.

Another object of the invention is to use a normal IR remote controller, and in particular the remote controller of television receivers, to control a plurality of user devices, even if situated at a distance and not visible.

In this respect, a remote control device has recently been proposed for remotely controlling by infrared signals a user device which is not visible to the infrared transmitter. In practice the device, provided for controlling by means of an IR remote controller an IR receiver associated with the user device to be controlled (video recorder, satellite receiver, decoder, air conditioner, etc.) requires that between the IR transmitter and the IR receiver there be interposed a first IR/RF converter positioned within the room from which the user device is to be controlled, and able to receive infrared signals from the traditional remote controller and to convert them into radio signals, and a second RF/IR converter positioned in the room in which the user device to be controlled exists. The two converters therefore perform the function of extending by means of radio signals the operability of a normal remote control device using infrared signals, by partly overcoming the limits of these latter.

However even this known solution presents limits, in that it is expressly provided for controlling user devices comprising an IR receiver and is unable to control any of those user devices traditionally constructed to be controlled by RF signals, such as lights, curtains, alarms and roll shutters, for which it would be necessary to convert the received infrared signal into an RF signal for controlling the user device. Consequently a further object of the invention is to remotely control non-visible user devices by using radiofrequency control systems.

These and further objects which will be apparent from the ensuing description are attained, according to the invention, by a multi-user remote control device as described in claim 1.

Some preferred embodiments of the invention are described hereinafter with reference to the accompanying drawings, in which:

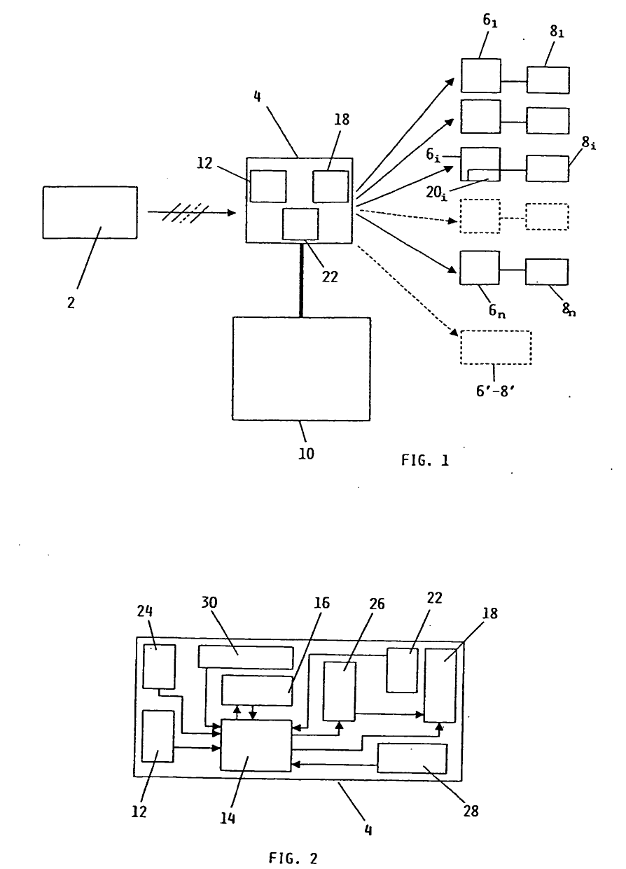

FIG. 1 is a schematic block diagram of a first embodiment of the remote control device according to the invention;

FIG. 2 is a detailed scheme of the conversion and processing unit;

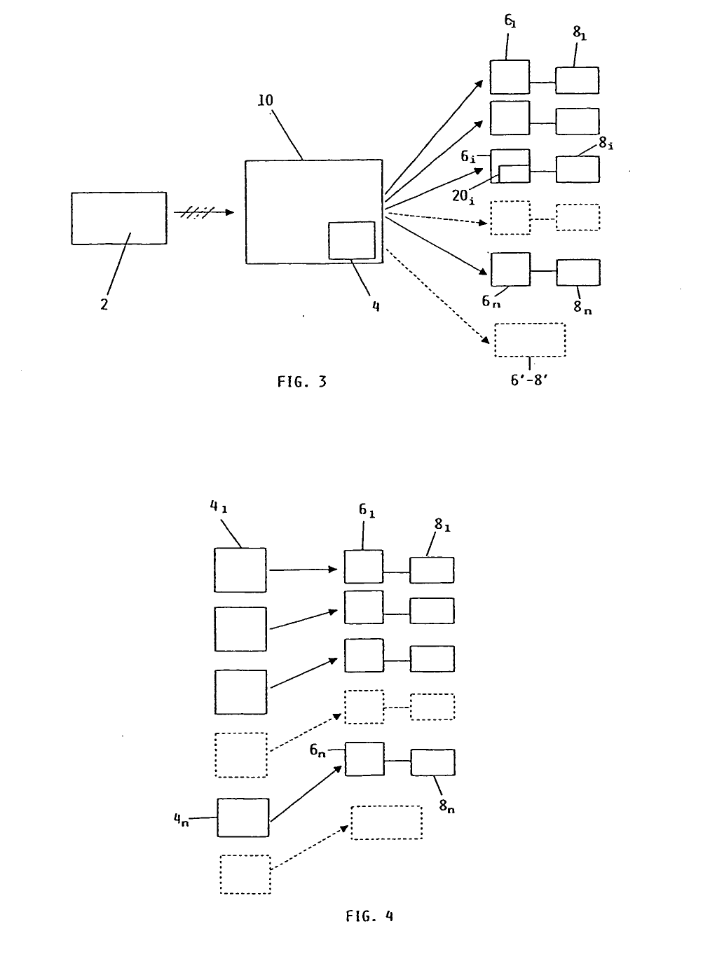

FIG. 3 is a different embodiment of the device according to the invention; and

FIG. 4 shows a particular implementation thereof.

In the embodiment shown in FIGS. 1 and 2, the remote control device according to the invention comprises a portable transmitter 2, a conversion and processing unit 4 and a plurality of receivers 6ᵢ (i=2, 3, . . . n) associated with corresponding user devices indicated by the reference numeral 8ᵢ.

The transmitter 2 is an infrared (IR) signal transmitter with n channels. It can consist of a traditional remote control device for a television receiver 10 or a similar dedicated device, or a remote control device with a certain number of keys intended for the television receiver and with other dedicated keys, or finally a remote control device with a keypad intended for the television receiver and an additional key for its conversion into a dedicated keypad.

In its basic version the conversion and processing unit 4 comprises:

a receiver 12 for IR signals, with n channels tuned to the n channels of the IR transmitter 2,

a microcontroller 14 for controlling the device,

a non-volatile memory 16 associated with the microcontroller 14, and

an RF radio signal transmitter 18 with n channels.

The receivers 6ᵢ are n RF signal receivers, tuned to the n channels of the RF transmitter 18 contained in the conversion and processing unit 4.

With each receiver 6ᵢ there is associated a user device 8ᵢ to be controlled, which can consist of a door, a gate, a roll shutter, a curtain, a light, an alarm, etc.

Some RF receivers 6′ may be integrated into the relative user device 8′, as represented by the rectangle 6′-8′ in FIG. 1.

The remote control device of the invention operates in the following manner.

When the operator wishes to remotely operate for example a gate, he operates the corresponding key on the remote controller 2 (IR transmitter) after pointing the remote controller in the direction of the conversion and processing unit 4.

The encoded IR signal, transmitted by the transmitter 2, is received by the receiver 12, which by means of the microcontroller 14 converts it into a RF signal, which is transmitted by the transmitter 18 to the receiver 6ᵢ, tuned for said signal and associated with the operating equipment 8ᵢ on the gate.

In this manner, by virtue of this transformation of the IR signal into a RF signal, the gate operating equipment 8ᵢ can be activated even if not visible from the spot from which the command is transmitted.

If instead the operator wishes to switch on an external light, he has merely to press the key of the remote controller corresponding to that light, in order to generate an IR signal, which is received by the IR receiver 12 of the conversion and processing unit 4. Here the IR signal is converted into a control signal for the transmitter 18, which transmits along the appropriate RF channel a radio signal able to reach the receiver 6ᵢ associated with the light to be switched on.

As stated, the transmitter 2 can consist of a normal remote controller for a television receiver 10, in which the control keys can be made to emit IR signals for this different function by an appropriate key, with which the remote controller can be provided; alternatively the television receiver remote controller can be provided not only with the normal keys for controlling the television receiver, but also with further keys to be used for the purpose of the invention.

In a different embodiment shown in FIG. 3, the conversion and processing unit 4 is housed in the television receiver and is provided, or alternatively the television receiver itself is provided, with its own software to display on the screen of this latter the state of all the user devices under control. However this function requires that the device of the invention also comprises, for each user device 8ᵢ an additional RF transmitter 20ᵢ associated with the RF receiver 6ᵢ and able to generate a signal confirming the reception of the corresponding activation or deactivation command.

This confirmation signal is received by a receiver 22 provided in the conversion and processing unit 4.

If software for displaying the state of the user devices 8ᵢ on the screen of the television receiver 10 is not provided, this user state can be displayed on a panel provided in the unit 4 and separate from the screen of the television receiver. In this case the unit 4 comprises not only said display panel but also a circuit 30 for optically and acoustically indicating the state of said user devices. Alternatively, the receiver 22 can be associated with a modem for remote transmission of the state of user devices 8ᵢ.

In a different embodiment, not shown in the drawings, the same remote controller 2 as that for the television receiver 10, with the same keys and same channels, is used to control the different user devices; however in this case the conversion and processing unit 4 must be disposed in a position distant from the television receiver, in order to be able to utilize the directionality of the remote controller to control the television remote 10 or the other user devices 8ᵢ at choice.

Correct operation of the device, and in particular the compatibility of the remote controller with the conversion and processing unit 4, requires that this compatibility must be previously established, i.e. that the remote controller 2 has been recognized by the conversion and processing unit 4 and is able to dialogue with it.

For this purpose said conversion and processing unit 4 comprises in its interior a circuit 24 for learning the codes of the different commercial marks of IR remote controllers, this circuit being selectable with traditional systems to instruct the unit 4 to dialogue with that remote controller.

The conversion and processing unit 4 must also be able to dialogue with different receivers 6ᵢ and must therefore possess the codes of the various RF channels. These codes can be individual to the conversion and processing unit 4, in which case they can activate only RF receivers compatible with these codes, or alternatively, if they are required to activate RF receivers of already installed user devices, they must previously learn the codes of the relative RF channels.

For the first eventuality, the conversion and processing unit 4 comprises an encoder 26 able to feed its codes to the RF transmitter 18 when commanded by the microcontroller 14.

For the second eventuality, the conversion and processing unit 4 comprises a circuit 28 for learning the codes of the RF remote controllers of already installed user devices 8ᵢ.

As the circuit 28 for learning codes of channels of the RF remote controller relative to already installed user devices consists essentially of an RF receiver, this can also perform the function of the receiver 22, i.e. of receiving the confirmation signals of the activation and deactivation commands for the different user devices.

From the aforegoing it is apparent that the multi-user remote control device of the invention is substantially more advantageous that traditional multi-user remote control devices, whether IR or RF, and in particular:

it is practically insensitive to radio disturbances in that the mobile remote controller 2 uses IR signals while the transmissions using RF signals take place between fixed equipment, so that appropriate expedients can be used to reduce interference by external signals to a minimum,

a single remote controller can be used for a plurality of user devices, and this can be made compatible with IR and RF systems practically of any type.

In an advantageous embodiment, shown in FIG. 4, each user device 8ᵢ, which can be for example a winding motor of a roll shutter, can have its own associated conversion and processing unit 4, which is positioned in the room in which the user device is installed. In this manner a simple IR remote controller provided with only one or two channels can control practically an unlimited number of user devices, by being taken into the various rooms to operate the roll shutters contained therein.

In a different embodiment not shown in the drawings, the remote controller 2 comprises not only a plurality of keys associated with n IR channels, but also one or more keys associated with RF channels, for the direct transmission of commands to a predetermined number of receivers 6ᵢ.

Naturally these keys associated with RF channels can also form part of a remote controller separate from the remote controller 2 of the television receiver 10.

In another embodiment, not shown in the drawings, the RF transmitter 20ᵢ associated with one or more user devices 8ᵢ is able to automatically feed to the receiver 22 the state of that user device, i.e. independently of the fact that there has previously been a command by the operator. This embodiment is advantageous if the user device 8ᵢ consists for example of an alarm sensor.

In another embodiment, also not shown in the drawings, the operator can act directly on the receiver 22 with an RF remote controller. This embodiment is advantageous if the user device 8ᵢ must be able to indicate a danger or emergency situation (remote assistance).

1. A multi-user remote control device characterised by comprising:
an IR transmitter (2) with a multiple number n of channels,
an IR receiver (12) with n channels tuned to the n channels of the IR transmitter (2),
an RF transmitter (18) associated with the IR receiver (12) and provided with n channels which can be activated via the n connection channels between said IR transmitter (2) and said IR receiver (12),
n RF receivers (6ᵢ), each directly associated with a user device (8ᵢ) and tuned to one of the n channels of said RF transmitter (18).

2. A device as claimed in claim 1, characterised by also comprising at least one RF transmitter for the direct control of an RF receiver (6ᵢ), associated with at least one user device (8ᵢ).

3. A device as claimed in claim 1, characterised in that with the IR transmitter (2) there is physically associated at least one RF transmitter for the direct control of a RF receiver (6ᵢ) directly associated with a user device (8ᵢ).

4. A device as claimed in claim 1, characterised in that said IR transmitter (2) is a normal remote control device for a television receiver (10).

5. A device as claimed in claim 4, characterised in that said IR receiver (12) and said RF transmitter (18) associated therewith are housed within said television receiver (10).

6. A device as claimed in claim 1, characterised by comprising an additional RF transmitter (20ᵢ), associated with at least one user device (8ᵢ), and e single RF receiver (22) operationally coordinated with said additional RF transmitter (20ᵢ) and provided with means (10, 30) for indicating the state of said user device (8ᵢ).

7. A device as claimed in claim 6, characterised by comprising at least one used device (20ᵢ) able to change its state independently of any command by the operator.

8. A device as claimed in claim 1, characterised by comprising an additional RF transmitter (20ᵢ) associated with the RF received (6ᵢ) controlling at least one user device (8ᵢ) and a single RF receiver (22) operationally coordinated with said additional RF transmitter (20ᵢ) and provided with means (30) for indicating the state of said user device (8ᵢ), said additional RF transmitter (20i) being provided to transmit to the RF receiver (22) response information concerning the effected control by the RF transmitter (18) and/or concerning the state of operation of said user devices (8ᵢ).

9. A device as claimed in claims 6 and 8, characterised in that said single RF receiver (22) is housed inside said television receiver (10).

10. A device as claimed in claim 1, characterised in that at least one RF receiver (6ᵢ) is integrated into the relative user device (8ᵢ).

11. A device as claimed in claim 9, characterised by comprising software for displaying on the screen of the television receiver (10) the situation regarding the user devices (8ᵢ) under control.

12. A device as claimed in claims 6 and 8, characterised in that a modem for remote transmission of the state of said user device (8ᵢ) is associated with said single RF receiver (22).

13. A device as claimed in claim 11, characterised in that the software for displaying the situation regarding the user devices (8ᵢ) under control forms part of the television receiver (10).

14. A device as claimed in claim 5, characterised in that said remote controller for the television receiver (10) is provided, for controlling said user devices (8ᵢ), with n channels different from the control channels of the television receiver and selectable by dedicated keys.

15. A device as claimed in claim 5, characterised in that said remote controller for the television receiver (10) is provided, for controlling said user devices (8ᵢ), with n channels different from the control channels of the television receiver but selectable by the same keys, after there have been switched by a suitable additional key.

16. A device as claimed in claim 4, characterised in that said IR receiver (12) and said RF transmitter (18) associated therewith are installed in a position distant from said television receiver (10), the remote controller of which uses for controlling said user devices (8ᵢ) the same channels used for controlling said television receiver.

17. A device as claimed in claim 1, characterised by comprising, for each user device (8ᵢ), an RF receiver (6ᵢ) operationally connected to an RF transmitter (18ᵢ), which is coordinated with its own IR receiver (12ᵢ) and is separate from the other RF transmitters (18ᵢ), all the IR receivers (12ᵢ) being individually able to dialogue with a single IR transmitter (2) using the same channels.
